(19) United States
(12) Patent Application Publication
(10) Pub. No.: US 2007/0146543 A1
(43) Pub. Date: Jun. 28, 2007

(54) VOLUME CONFIGURATIONS IN MOTION CAPTURE

(76) Inventor: DEMIAN GORDON, Culver City, CA (US)

Correspondence Address: PROCOPIO, CORY, HARGREAVES & SAVITCH LLP, 530 B STREET, SUITE 2100, SAN DIEGO, CA, 92101, US

(21) Appl. No.: 11/614,861

(22) Filed: Dec. 21, 2006

Related U.S. Application Data
(60) Provisional application No. 60/753,845, filed on Dec. 23, 2005.
(60) Provisional application No. 60/753,623, filed on Dec. 23, 2005.

(51) Int. Cl. H04N 7/00

(52) U.S. Cl. 348/475

(57) ABSTRACT

Enlarging a capture volume, comprising: positioning a first motion capture volume offset from a second motion capture volume in a direction that requires minimal motion capture camera reconfigurations, wherein a first plurality of motion capture cameras is configured around the first motion capture volume and a second plurality of motion capture cameras is substantially similarly configured around the second motion capture volume; connecting the first motion capture volume with the second motion capture volume using an extension corridor; minimally reconfiguring the first plurality and the second plurality of motion capture cameras; and adding an appropriate number of additional motion capture cameras.

### CROSS-REFERENCE TO RELATED APPLICATIONS

This application claims the benefit of priority of co-pending U.S. Provisional Patent Application Ser. No. 60/753,845 for “Volume Configurations for Motion Capture” and U.S. Provisional Patent Application Ser. No. 60/753,623 for “Laser Projection System”, both of which are filed on Dec. 23, 2005. This application is also related to U.S. patent application Ser. No. 10/427,114 for “System and Method for Capturing Facial and Body Motion” which is filed May 1, 2003. The disclosures of the above-referenced patent applications are incorporated herein by reference.

### BACKGROUND

The present invention relates to motion capture, and more particularly, to increasing the volume available for motion capture.

Motion capture systems are used to capture the movement of a real object and map it onto a computer-generated object. Such systems are often used in the production of motion pictures and video games for creating a digital representation of an object/person for use as source data to create a computer graphics animation.

A typical motion capture system includes multiple fixed motion capture cameras surrounding a volume of space and capturing motions of an actor who is wearing a suit with markers attached at various locations (e.g., having small reflective markers attached to the body and limbs). Cameras record the movement of the actor from different angles while illuminating the markers. The system then analyzes the images to determine the locations (e.g., as spatial coordinates) and orientation of the markers on the actor's suit in each frame. By tracking the locations of the markers, the system creates a spatial representation of the markers over time and builds a digital representation of the actor in motion. The motion is then applied to a digital model, which may then be textured and rendered to produce a complete CG representation of the actor and/or performance. This technique has been used by special effects companies to produce realistic animations in many popular movies.

### SUMMARY

Embodiments of the present invention provide for increasing the volume available for motion capture.

In one implementation, a method of enlarging a capture volume comprises: positioning a first motion capture volume offset from a second motion capture volume in a direction that requires minimal motion capture camera reconfigurations, wherein a first plurality of motion capture cameras is configured around the first motion capture volume and a second plurality of motion capture cameras is substantially similarly configured around the second motion capture volume; connecting the first motion capture volume with the second motion capture volume using an extension corridor; minimally reconfiguring the first plurality and the second plurality of motion capture cameras; and adding an appropriate number of additional motion capture cameras.

In another implementation, a large effective motion capture volume comprises: a first motion capture volume; a first plurality of motion capture cameras configured around the first motion capture volume; a second motion capture volume offset from the first motion capture volume in a direction that requires minimal motion capture camera reconfigurations; a second plurality of motion capture cameras substantially similarly configured around the second motion capture volume as the configuration of the first plurality of motion capture cameras around the first motion capture volume; an extension corridor configured to connect the first motion capture volume with the second motion capture volume, wherein the first plurality and the second plurality of motion capture cameras are minimally reconfigured; and a third plurality of motion capture cameras configured near said extension corridor.

Other features and advantages of the present invention will become more readily apparent to those of ordinary skill in the art after reviewing the following detailed description and accompanying drawings.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates one example of a standard-sized motion capture volume surrounded by a plurality of motion capture cameras;

FIG. 2 shows two standard-sized capture volumes connected in series to form an enlarged capture volume;

FIG. 3 illustrates one implementation of providing a larger capture volume for motion capture;

FIG. 4 illustrates a concept of geometrically repeating the pattern of diagonally connecting the standard-sized capture volumes (as shown in FIG. 3) in multiple directions to substantially enlarge the effective capture volume; and

FIG. 5 is a flowchart illustrating a method of enlarging an effective capture volume using a plurality of standard-sized motion capture volumes, where each capture volume is substantially similarly configured with a plurality of motion capture cameras around the capture volume.

### DETAILED DESCRIPTION

Implementations of the present invention include configuring capture volume in motion capture. In one implementation, capture volumes are connected using extension corridors to provide a larger capture volume for motion capture. The capture volumes are connected in directions that require only minimal motion capture camera reconfigurations for each capture volume. In one example, the capture volumes are connected diagonally using the extension corridors.

After reading this description it will become apparent to one skilled in the art how to implement the invention in various alternative implementations and alternative applications. However, although various implementations of the present invention will be described herein, it is understood that these implementations are presented by way of example only, and not limitation. As such, this detailed description of various alternative implementations should not be construed to limit the scope or breadth of the present invention as set forth in the appended claims.

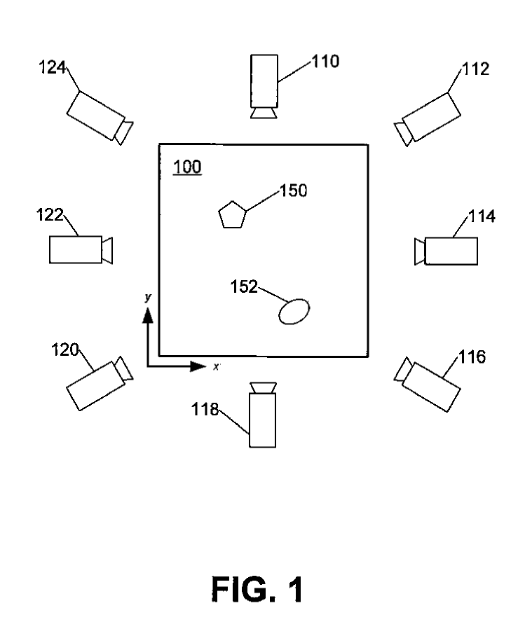

FIG. 1 illustrates one example of a standard-sized motion capture volume 100 surrounded by a plurality of motion capture cameras 110, 112, 114, 116, 118, 120, 122, 124 to capture motions of capture objects 150, 152. Typically, the capture objects 150, 152 are actors wearing suits with markers attached at various locations on the actors' body. Thus, in the illustrated implementation, motion capture cameras 110 and 118 provide −y and +y directional capture, respectively, of markers on the objects 150, 152, while motion capture cameras 114 and 122 provide −x and +x directional capture, respectively, of markers on the objects 150, 152. Cameras 112, 116, 120, 124 capture diagonal views of the markers on the objects 150, 152. However, in some configurations, there are substantially more motion capture cameras than are shown in FIG. 1. For example, one configuration may include 150 or more motion capture cameras placed at different positions around the capture volume as well as at different vertical levels (see, e.g., U.S. patent application Ser. No. 10/427,114 for “System and Method for Capturing Facial and Body Motion” filed May 1, 2003 for different configurations of motion capture cameras around a capture volume). Further, although the cameras 112, 116, 120, 124 in FIG. 1 are shown as being positioned at the corners of the capture volume in diagonal directions, a typical configuration will have no cameras positioned at the corners but on the sides. Thus, in one implementation, the cameras will be positioned at 90 degree angle with respect to each other, where each camera is positioned on each side next to the corner.

In one implementation, the standard-sized motion capture volume 100 comprises a floor area of approximately 25 feet by 25 feet, with a height of approximately 10 feet above the floor. Therefore, the motion capture volume 100 provides the objects 150, 152 a freedom to move within an approximate square area of about 25 feet by 25 feet on the floor and about 10 feet above the floor.

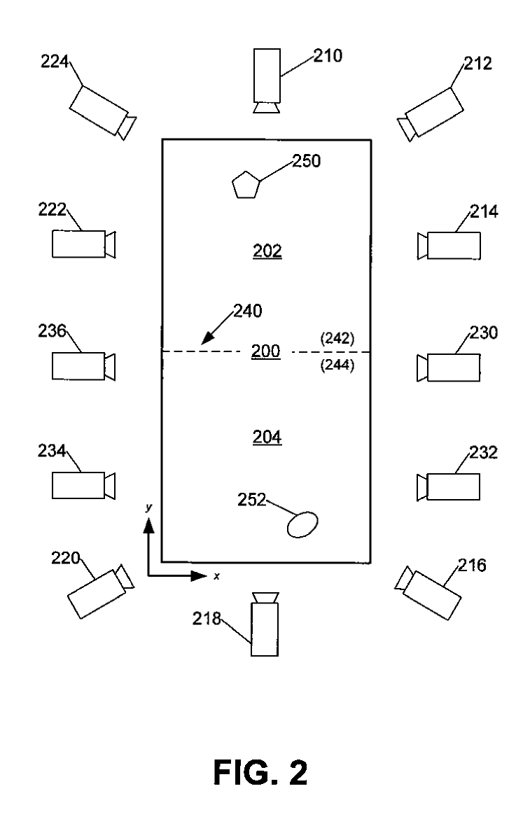

For various reasons, there may be a need to enlarge the motion capture volume. One simple solution would be to connect one or more of the standard-sized capture volumes as shown in FIG. 2. In FIG. 2, the two standard-sized capture volumes 202, 204 (each volume configured similarly in size to the capture volume 100) are connected along a line 240 to form an enlarged capture volume 200. However, by connecting the two capture volumes 202, 204 along the line 240, motion capture cameras positioned along side 244 of the capture volume 202 and motion capture cameras positioned along side 242 of the capture volume 204 are removed. Thus, camera 210 would have be used to provide −y directional capture of markers on the object 252 (which may be over 50 feet away from the camera 210), while camera 218 would have be used to provide +y directional capture of markers on the object 250 (which may be over 50 feet away from the camera 218).

However, motion capture cameras have certain depth of field so that if the capture object is beyond that depth of field, the cameras may not accurately capture the markers or cause the captured images to be out of focus. Further, one or more capture objects being out of focus may cause a “near-far” problem in which large markers on far capture objects may become confused with small markers on near capture objects. For example, since the capture object 250 may be beyond the depth of field of the camera 218, large body markers on the capture object 250 and small facial markers on the capture object 252 may not be distinguishable in images captured on the camera 218.

Although it may be possible to accurately cover the entire enlarged capture volume, such as volume 200, with motion capture cameras that have high depth of field, this may require very complicated camera reconfigurations to place the cameras in appropriate positions and elevations. Thus, in this configuration, a volume configuration of one capture volume cannot be re-used.

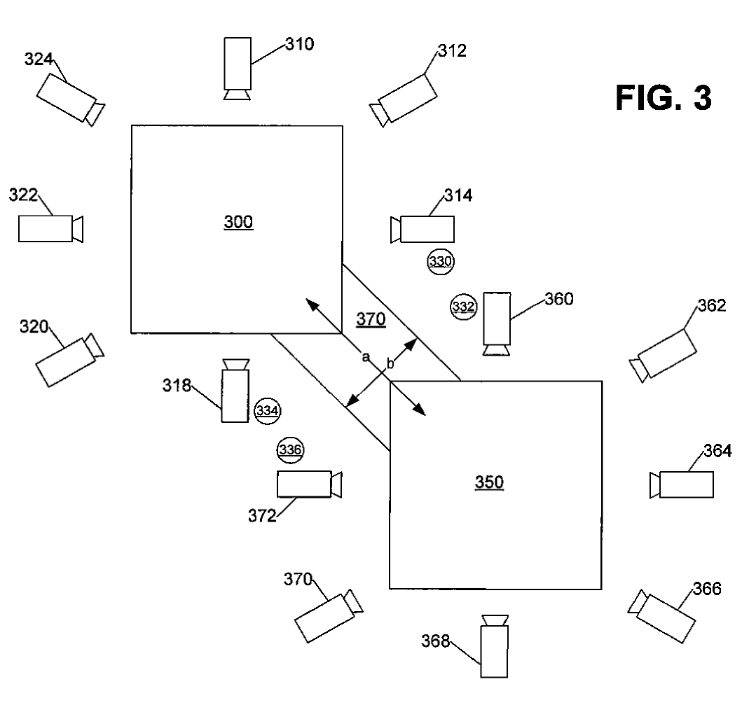

FIG. 3 illustrates one implementation of providing a larger capture volume for motion capture. In the illustrated implementation of FIG. 3, two standard-sized motion capture volumes 300, 350 are connected diagonally with an extension corridor 370, which provides enough space for capture objects to pass from one capture volume 300 or 350 to another capture volume 350 or 300. Thus, this implementation provides an effective capture volume encompassing an area that combines volumes 300, 350, 370, and allows substantial maintenance of camera configurations for each standard-sized motion capture volume.

For example, for the motion capture volume 300 similar to the standard-sized motion capture volume 100, motion capture cameras 310, 312, 314, 318, 320, 322, 324 (in similar position to cameras 110, 112, 114, 118, 120, 122, 124) are kept. Only a motion capture camera in similar position to camera 116 in FIG. 1 is removed to provide for the extension corridor 370. In its place, additional motion capture cameras 330, 332, 334, 336 are appropriately positioned to cover capture objects within the extension corridor 370 as well as corner areas of the capture volume 300. In some implementations, if the cameras are positioned all along the sides and not at the corners as described above, no cameras may have to be removed to provide a space for the extension corridor 370. Although only four cameras 330, 332, 334, 336 are illustrated, there may be more cameras needed to cover the entire extension corridor 370. Typically, the extension corridor 370 may measure approximately 20 feet in length (‘a’ in FIG. 3) and 12 feet in width (‘b’ in FIG. 3) with 60 to 80 motion capture cameras configured to cover the area of the corridor 370.

Similarly, for the motion capture volume 350 like the standard-sized motion capture volume 100, motion capture cameras 360, 362, 364, 366, 368, 370, 372 (in similar position to cameras 110, 112, 114, 116, 118, 120, 122) are kept. Only a motion capture camera in similar position to camera 124 in FIG. 1 is removed to provide for the extension corridor 370. In its place, additional motion capture cameras 330, 332, 334, 336 are appropriately positioned to cover capture objects within the extension corridor 370 as well as corner areas of is the capture volume 350. Accordingly, it can be seen that by connecting a plurality of standard-sized motion capture volumes diagonally using extension corridors, the effective capture volume can be enlarged with only minimal motion capture camera reconfigurations from one added capture volume to another added capture volume. In general, the effective capture volume can be enlarged by connecting a plurality of standard-sized capture volumes in directions that require only minimal motion capture camera reconfigurations for each added capture volume.

The illustrated implementation of FIG. 3, in which an effective capture volume is more than doubled, provides the ability to have a relatively long “run-through” (e.g., an actor or group of actors performs while moving through the substantial portion of the effective capture volume). Thus, the “run-through” may involve setting up sets in both areas (or capture volumes 300, 350) and having a scene that starts in one set location, traverses to another set location, and finishes in yet another final set location. This may also reduce post processing rough integration (RINT)/final integration (FINT) blending problems in which shots captured in one scene are blended in with shots captured in another scene because the two scenes were made with two relatively short “run-throughs”.

The illustrated implementation also provides the ability to use one capture volume (e.g., capture volume 300) for an actual capture shoot while the other capture volume (e.g., capture volume 350) is being set up for later use. Thus, in the example above, once the capture shoot is finished at capture volume 300, capture cameras in the capture volume 300 can be turned off and the subsequent shooting is moved to the capture volume 350. This would substantially reduce the initial setup time since the capture volume for the next shoot is prepared during the current capture shoot.

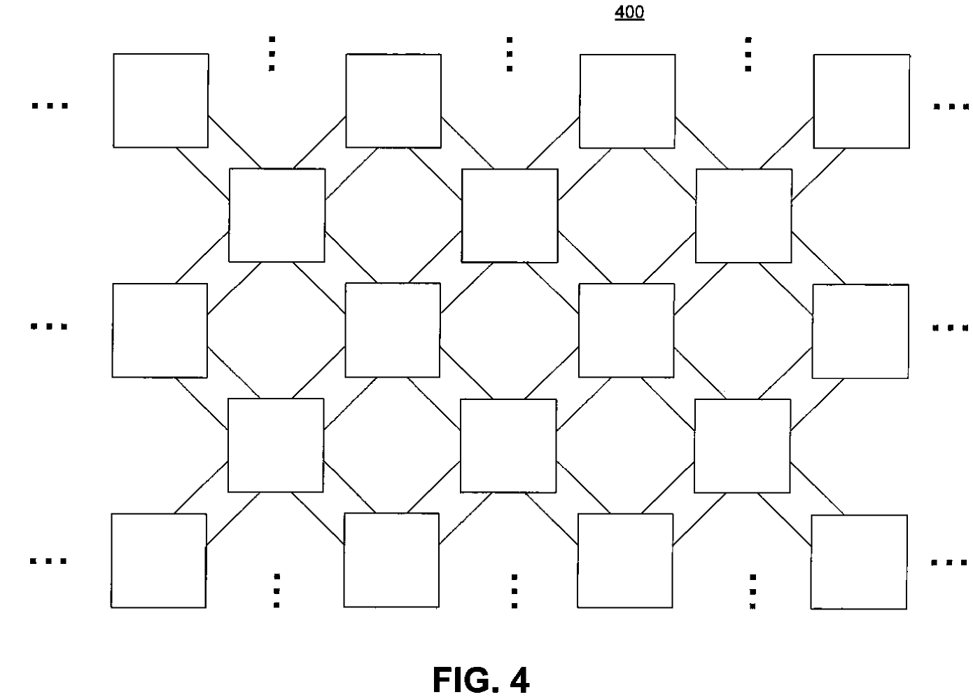

FIG. 4 illustrates a concept of geometrically repeating the pattern of diagonally connecting the standard-sized capture volumes (as shown in FIG. 3) in multiple directions to substantially enlarge the effective capture volume 400. As shown in the illustrated concept, the effective capture volume 400 can be enlarged to any desired size by connecting additional standard-sized capture volumes in appropriate directions.

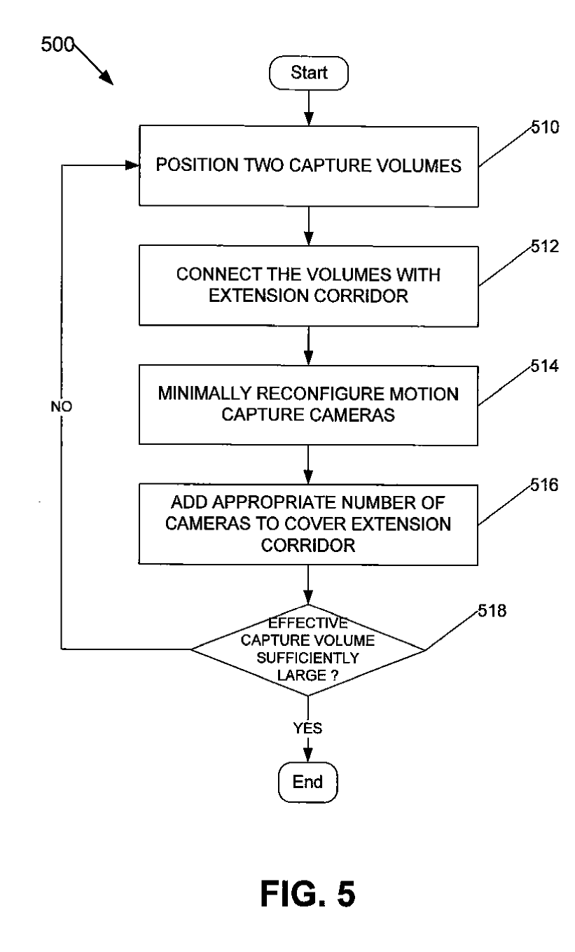

FIG. 5 is a flowchart 500 illustrating a method of enlarging an effective capture volume using a plurality of standard-sized motion capture volumes, where each capture volume is substantially similarly configured with a plurality of motion capture cameras around the capture volume. Initially, the two standard-sized motion capture volumes are positioned, at 510, in a selected direction that requires minimal motion capture camera reconfigurations for the two capture volumes. In one implementation, the motion capture volumes are positioned diagonally. The positioned capture volumes are connected, at 512, along the selected direction with an extension corridor. The motion capture cameras in the capture volumes are minimally reconfigured, at 514. An appropriate number of motion capture cameras are added, at 516, to cover the extension corridor and the corner areas of the capture volumes. At 518, a check is made to determine whether the effective capture volume formed by the two connected capture volumes and the extension corridor is sufficiently large for the desired purpose. If the effective capture volume is determined not to be sufficiently large, the process returns to 510 to connect an additional capture volume to the existing effective capture volume.

As the effective capture volume is enlarged, the complexity of the capture volume layout increases. Currently, the layout or floor plan is prepared by a set layout manager and the workers tape the floor of the capture volume according to the prepared floor plan. However, the taping of the floor is approximated and some amount of error is almost always introduced. Further, as the capture volume increases, the floor layout work takes longer to complete. Accordingly, the capture volume floor layout work can be done using laser projection.

In one implementation, the capture volume layout system includes an overhead reference camera, a frame-grabber, a laser projection system, and a computer (e.g., a tablet PC). The frame-grabber digitizes each take from the overhead reference camera. The laser projection system projects floor plans of each virtual set onto the physical floor of the capture volume. Thus, the projected laser light enables the workers to lay out the sets more quickly. The lines (drawn by the laser light) can be left on during the capture session by appropriately selecting the laser light so that it does not interfere with the operation of the capture cameras during the session. Further, the set layout manager can map out each actor's start position, end position, and path taken. The start and end positions can be used to match previous sessions more closely and to visualize paths taken by actors.

In another implementation, the laser projection system projects virtual objects and guides to aid the actor during the capture session. For example, the virtual objects may include background objects or other objects (projected on the floor or wall) that the actor interfaces with in the final version of the movie. Background objects may include trees, cars, mountains, and other related objects. Other projected objects may also include dialogues for the actors in the capture volume so that the actors can move their mouths and the mouth movements can be accurately captured. Thus, these virtual objects would provide references for the actor to accurately move about the capture volume.

Additional variations and implementations are also possible with the capture volume layout system. For example, different light projection systems (other than laser light) could be used. Alternatively, a different mechanism can be used to display the lines, such as embedded lighting in the floor.

Various illustrative implementations of the present invention have been described. However, one of ordinary skill in the art will recognize that additional implementations are also possible and within the scope of the present invention. For example, dimensions and/or shape for a standard-sized capture volume can be varied. Thus, for example, the standard-sized capture volume can be 10 feet by 10 feet, or can be a circle or rectangle rather than a square. Furthermore, dimensions, shape, and/or number of extension corridors can also be varied. Thus, for example, the capture volumes can be connected with multiple extension corridors that are oval in shape. In other variations, the motion capture cameras can be configured to capture objects not only within the “hot spot” of the standard-sized capture volume (e.g., within the 25′ by 25′ square) but even objects that are outside the capture volume.

Accordingly, the present invention is not limited to only those implementations described above.

What is claimed is:

1. A method of enlarging a capture volumer comprising:
positioning a first motion capture volume offset from a second motion capture volume in a direction that requires minimal motion capture camera reconfigurations,
wherein a first plurality of motion capture cameras is configured around said first motion capture volume and a second plurality of motion capture cameras is substantially similarly configured around said second motion capture volume;
connecting said first motion capture volume with said second motion capture volume using an extension corridor;
minimally reconfiguring said first plurality and said second plurality of motion capture cameras; and
adding an appropriate number of additional motion capture cameras.

2. The method of claim 1, wherein said direction that requires minimal motion capture camera reconfigurations is a diagonal direction.

3. The method of claim 1, further comprising
configuring said extension corridor wide enough for capture objects to pass from said first motion capture volume to said second motion capture volume.

4. The method of claim 1, wherein said minimally reconfiguring includes
substantially maintaining configurations of said first plurality of motion capture cameras around said first motion capture volume and said second plurality of motion capture cameras around said second motion capture volume.

5. The method of claim 1, wherein said minimally reconfiguring includes:
reconfiguring one or more motion capture cameras of said first plurality of motion capture cameras near said extension corridor; and
reconfiguring one or more motion capture cameras of said second plurality of motion capture cameras near said extension corridor.

6. The method of claim 1, wherein said minimally reconfiguring includes
removing one or more motion capture cameras of said first plurality of motion capture cameras near said extension corridor; and
removing one or more motion capture cameras of said second plurality of motion capture cameras near said extension corridor.

7. The method of claim 1, wherein said adding an appropriate number of additional motion capture cameras includes
adding motion capture cameras around said extension corridor to cover said extension corridor and corner areas of said first motion capture volume and said second motion capture volume.

8. A large effective motion capture volume, comprising:
a first motion capture volume;
a first plurality of motion capture cameras configured around said first motion capture volume;
a second motion capture volume offset from said first motion capture volume in a direction that requires minimal motion capture camera reconfigurations;
a second plurality of motion capture cameras substantially similarly configured around said second motion capture volume as the configuration of said first plurality of motion capture cameras around said first motion capture volume;
an extension corridor configured to connect said first motion capture volume with said second motion capture volume,
wherein said first plurality and said second plurality of motion capture cameras are minimally reconfigured; and a third plurality of motion capture cameras configured near said extension corridor.

9. The volume of claim 8, wherein said direction that requires minimal motion capture camera reconfigurations is a diagonal direction.

10. The volume of claim 8, wherein said extension corridor is configured wide enough for capture objects to pass from said first motion capture volume to said second motion capture volume.

11. The volume of claim 8, wherein configurations of said first plurality of motion capture cameras around said first motion capture volume and said second plurality of motion capture cameras around said second motion capture volume are substantially maintained.

12. The volume of claim 8, wherein
one or more motion capture cameras of said first plurality of motion capture cameras near said extension corridor are reconfigured; and
one or more motion capture cameras of said second plurality of motion capture cameras near said extension corridor are reconfigured.

13. The volume of claim 8, wherein
one or more motion capture cameras of said first plurality of motion capture cameras near said extension corridor are removed; and
one or more motion capture cameras of said second plurality of motion capture cameras near said extension corridor are removed.

14. The volume of claim 8, wherein said third plurality of motion capture cameras is configured near said extension corridor to cover said extension corridor and corner areas of said first motion capture volume and said second motion capture volume.

15. The volume of claim 8, further comprising
a capture volume layout system.

16. The volume of claim 15, wherein said capture volume layout system includes
a laser projection system configured to project floor plans of each virtual capture volume onto a physical floor of the capture volume using laser light,
wherein projected laser light allows relatively quick lay out of sets onto the capture volume.

17. The volume of claim 16, wherein lines projected by the laser light are left on during a motion capture session by appropriately selecting the laser light so that it does not interfere with the operation of motion capture cameras during the motion capture session.

18. The volume of claim 15, wherein said capture volume layout system includes
a laser projection system configured to project virtual objects and guides to aid the actor during the capture session.

19. The volume of claim 18, wherein said virtual objects include background objects including
trees, cars, mountains, and other related objects.

20. The volume of claim 18, wherein said virtual objects include dialogues for actors in the large effective motion capture volume.

21. A storage medium configured to store at least one image created using a method of enlarging a capture volume, the method comprising:
positioning a first motion capture volume offset from a second motion capture volume in a direction that requires minimal motion capture camera reconfigurations,
wherein a first plurality of motion capture cameras is configured around said first motion capture volume and a second plurality of motion capture cameras is substantially similarly configured around said second motion capture volume;
connecting said first motion capture volume with said second motion capture volume using an extension corridor;
minimally reconfiguring said first plurality and said second plurality of motion capture cameras; and
adding an appropriate number of additional motion capture cameras.

22. The storage medium of claim 21, wherein said at least one image is configured to form a motion picture.

23. A storage medium configured to store at least one image created within a large effective motion capture volume, the volume comprising:
a first motion capture volume;
a first plurality of motion capture cameras configured around said first motion capture volume;
a second motion capture volume offset from said first motion capture volume in a direction that requires minimal motion capture camera reconfigurations;
a second plurality of motion capture cameras substantially similarly configured around said second motion capture volume as the configuration of said first plurality of motion capture cameras around said first motion capture volume;
an extension corridor configured to connect said first motion capture volume with said second motion capture volume,
wherein said first plurality and said second plurality of motion capture cameras are minimally reconfigured; and a third plurality of motion capture cameras configured near said extension corridor.

24. The storage medium of claim 23, wherein said at least one image is configured to form a motion picture.
